(19) United States
(12) Patent Application Publication
(10) Pub. No.: US 2026/0113780 A1
(43) Pub. Date: Apr. 23, 2026

(54) RANDOM ACCESS RESOURCE ALLOCATION BASED ON UPLINK POWER

(71) Applicant: QUALCOMM Incorporated, San Diego, CA (US)

(72) Inventors: Raviteja PATCHAVA, San Diego, CA (US); Jing SUN, San Diego, CA (US); Xiaoxia ZHANG, San Diego, CA (US); Junyi LI, Greentown, PA (US); Jing JIANG, San Diego, CA (US)

(21) Appl. No.: 18/920,735

(22) Filed: Oct. 18, 2024

(51) Int. Cl. H04W 74/0833; H04B 17/318

(52) U.S. Cl. CPC H04W 74/0833; H04B 17/328

(57) ABSTRACT

Methods, systems, and devices for wireless communications are described. A network entity may configure one or more random access channel (RACH) resource sets and a user equipment (UE) may receive a configuration message from the network entity. The configuration message may indicate multiple RACH resource sets for the UE. Each RACH resource set may be associated with a respective range of targeted uplink power values, with a respective quantity of random access occasions, with a respective RACH format, or a combination thereof. The UE may select a RACH resource set from the configured RACH resource sets based on an uplink power value associated with the UE. The UE may transmit one or more random access messages to the network entity in accordance with the selected RACH resource set.

### FIELD OF TECHNOLOGY

The following relates to wireless communications, including random access resource allocation based on uplink power.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, a configuration message indicating a set of multiple random access channel resource sets for the UE, where each random access channel resource set of the set of multiple random access channel resource sets is associated with a respective range of targeted uplink power values, selecting a random access channel resource set from the set of multiple random access channel resource sets based on an uplink power value associated with the UE, and transmitting, to the network entity, one or more random access messages in accordance with one or more resources of the random access channel resource set based on selecting the random access channel resource set.

A UE for wireless communications is described. The UE may include one or more memories storing processor executable code, and one or more processors coupled with the one or more memories. The one or more processors may individually or collectively be operable to execute the code to cause the UE to receive, from a network entity, a configuration message indicating a set of multiple random access channel resource sets for the UE, where each random access channel resource set of the set of multiple random access channel resource sets is associated with a respective range of targeted uplink power values, select a random access channel resource set from the set of multiple random access channel resource sets based on an uplink power value associated with the UE, and transmit, to the network entity, one or more random access messages in accordance with one or more resources of the random access channel resource set based on selecting the random access channel resource set.

Another UE for wireless communications is described. The UE may include means for receiving, from a network entity, a configuration message indicating a set of multiple random access channel resource sets for the UE, where each random access channel resource set of the set of multiple random access channel resource sets is associated with a respective range of targeted uplink power values, means for selecting a random access channel resource set from the set of multiple random access channel resource sets based on an uplink power value associated with the UE, and means for transmitting, to the network entity, one or more random access messages in accordance with one or more resources of the random access channel resource set based on selecting the random access channel resource set.

A non-transitory computer-readable medium storing code for wireless communications is described. The code may include instructions executable by one or more processors to receive, from a network entity, a configuration message indicating a set of multiple random access channel resource sets for the UE, where each random access channel resource set of the set of multiple random access channel resource sets is associated with a respective range of targeted uplink power values, select a random access channel resource set from the set of multiple random access channel resource sets based on an uplink power value associated with the UE, and transmit, to the network entity, one or more random access messages in accordance with one or more resources of the random access channel resource set based on selecting the random access channel resource set.

Some examples of the method, UEs, and non-transitory computer-readable medium described herein may further include operations, features, means, or instructions for receiving an indication of a mapping between each range of targeted uplink power values and each random access channel resource set, where selecting the random access channel resource set may be based on the indication of the mapping.

In some examples of the method, UEs, and non-transitory computer-readable medium described herein, each random access channel resource set of the set of multiple random access channel resource sets may be associated with a respective quantity of random access occasions.

In some examples of the method, UEs, and non-transitory computer-readable medium described herein, selecting the random access channel resource set may include operations, features, means, or instructions for selecting a random access preamble from a set of multiple random access preambles associated with the selected random access channel resource set.

In some examples of the method, UEs, and non-transitory computer-readable medium described herein, each random access channel resource set of the set of multiple random access channel resource sets may be associated with a unique set of multiple random access preambles.

In some examples of the method, UEs, and non-transitory computer-readable medium described herein, each random access channel resource set of the set of multiple random access channel resource sets may be associated with a respective random access channel format.

In some examples of the method, UEs, and non-transitory computer-readable medium described herein, a first random access occasion includes two or more portions, each of the two or more portions respectively corresponding to a first random access channel resource set associated with a first random access channel format, a second random access occasion includes a single portion that corresponds to a second random access channel resource set associated with a second random access channel format different than the first random access channel format, and the first random access occasion and the second random access occasion occupy a same set of time domain resources.

In some examples of the method, UEs, and non-transitory computer-readable medium described herein, a first random access channel format may be associated with a first quantity of repetitions and a second random access channel format may be associated with a second quantity of repetitions that may be greater than the first quantity and one or more first targeted uplink power values of a first range associated with the first random access channel format may be greater than one or more second targeted uplink power values of a second range associated with the second random access channel format.

In some examples of the method, UEs, and non-transitory computer-readable medium described herein, selecting the random access channel resource set may include operations, features, means, or instructions for selecting a random access channel format associated with the selected random access channel resource set, where the one or more random access messages may be transmitted in accordance with a quantity of repetitions in accordance with the selected random access channel format.

Some examples of the method, UEs, and non-transitory computer-readable medium described herein may further include operations, features, means, or instructions for detecting a change in the uplink power value associated with the UE, selecting a second random access channel resource set from the set of multiple random access channel resource sets different from the random access channel resource set based on detecting the change, and transmitting, to the network entity, one or more second random access messages in accordance with one or more second resources of the random access channel resource set based on selecting the second random access channel resource set.

Some examples of the method, UEs, and non-transitory computer-readable medium described herein may further include operations, features, means, or instructions for selecting a second random access channel resource set from the set of multiple random access channel resource sets different from the random access channel resource set based on one or more failures of the one or more random access messages and transmitting, to the network entity, one or more second random access messages in accordance with one or more second resources of the random access channel resource set based on selecting the second random access channel resource set.

Some examples of the method, UEs, and non-transitory computer-readable medium described herein may further include operations, features, means, or instructions for receiving an indication to use the uplink power value associated with the UE for selecting the random access channel resource set, where the selecting may be based on receiving the indication.

Some examples of the method, UEs, and non-transitory computer-readable medium described herein may further include operations, features, means, or instructions for receiving one or more reference signals from the network entity and calculating the uplink power value used based on a reference signal received power (RSRP) value measured in accordance with receiving the one or more reference signals.

A method for wireless communications by a network entity is described. The method may include configuring a set of multiple random access channel resource sets, where each random access channel resource set of the set of multiple random access channel resource sets is associated with a respective range of targeted uplink power values, outputting, to a UE, a configuration message indicating the set of multiple random access channel resource sets based on configuring the set of multiple random access channel resource sets, and obtaining, from the UE, one or more random access messages in accordance with one or more resources of a random access channel resource set in accordance with an uplink power value associated with the UE.

A network entity for wireless communications is described. The network entity may include one or more memories storing processor executable code, and one or more processors coupled with the one or more memories. The one or more processors may individually or collectively be operable to execute the code to cause the network entity to configure a set of multiple random access channel resource sets, where each random access channel resource set of the set of multiple random access channel resource sets is associated with a respective range of targeted uplink power values, output, to a UE, a configuration message indicating the set of multiple random access channel resource sets based on configuring the set of multiple random access channel resource sets, and obtain, from the UE, one or more random access messages in accordance with one or more resources of a random access channel resource set in accordance with an uplink power value associated with the UE.

Another network entity for wireless communications is described. The network entity may include means for configuring a set of multiple random access channel resource sets, where each random access channel resource set of the set of multiple random access channel resource sets is associated with a respective range of targeted uplink power values, means for outputting, to a UE, a configuration message indicating the set of multiple random access channel resource sets based on configuring the set of multiple random access channel resource sets, and means for obtaining, from the UE, one or more random access messages in accordance with one or more resources of a random access channel resource set in accordance with an uplink power value associated with the UE.

A non-transitory computer-readable medium storing code for wireless communications is described. The code may include instructions executable by one or more processors to configure a set of multiple random access channel resource sets, where each random access channel resource set of the set of multiple random access channel resource sets is associated with a respective range of targeted uplink power values, output, to a UE, a configuration message indicating the set of multiple random access channel resource sets based on configuring the set of multiple random access channel resource sets, and obtain, from the UE, one or more random access messages in accordance with one or more resources of a random access channel resource set in accordance with an uplink power value associated with the UE.

Some examples of the method, network entities, and non-transitory computer-readable medium described herein may further include operations, features, means, or instructions for outputting an indication of a mapping between each range of targeted uplink power values and each random access channel resource set, where obtaining the one or more random access messages may be based on the indication of the mapping.

In some examples of the method, network entities, and non-transitory computer-readable medium described herein, configuring the set of multiple random access channel resource sets may include operations, features, means, or instructions for allocating a respective quantity of random access occasions to each random access channel resource set of the set of multiple random access channel resource sets, where the one or more random access messages may be obtained in accordance with a random access occasion associated with a random access channel resource set selected by the UE.

In some examples of the method, network entities, and non-transitory computer-readable medium described herein, configuring the set of multiple random access channel resource sets may include operations, features, means, or instructions for allocating a respective set of multiple random access preambles to each random access channel resource set of the set of multiple random access channel resource sets, where the one or more random access messages may be obtained in accordance with a preamble associated with a random access channel resource set selected by the UE.

In some examples of the method, network entities, and non-transitory computer-readable medium described herein, configuring the set of multiple random access channel resource sets may include operations, features, means, or instructions for allocating a respective random access channel format to each random access channel resource set of the set of multiple random access channel resource sets, where the one or more random access messages may be obtained in accordance with a random access channel format associated with a random access channel resource set selected by the UE.

Some examples of the method, network entities, and non-transitory computer-readable medium described herein may further include operations, features, means, or instructions for allocating a first random access channel format to a first random access channel resource set of the set of multiple random access channel resource sets, allocating a second random access channel format different than the first random access channel format to a second random access channel resource set of the set of multiple random access channel resource sets, allocating a first random access occasion and a second random access occasion on a same set of time domain resources, and dividing the first random access occasion into two or more portions, each portion respectively corresponding to the first random access channel resource set, where the second random access occasion corresponds to the second random access channel resource set.

In some examples of the method, network entities, and non-transitory computer-readable medium described herein, a first random access channel format may be associated with a first quantity of repetitions and a second random access channel format may be associated with a second quantity of repetitions that may be greater than the first quantity and one or more first targeted uplink power values of a first range associated with the first random access channel format may be greater than one or more second targeted uplink power values of a second range associated with the second random access channel format.

Some examples of the method, network entities, and non-transitory computer-readable medium described herein may further include operations, features, means, or instructions for outputting an indication to use the uplink power value associated with the UE for selection of a random access channel resource set, where obtaining the one or more random access messages may be based on outputting the indication.

Some examples of the method, network entities, and non-transitory computer-readable medium described herein may further include operations, features, means, or instructions for outputting one or more reference signals to the UE, where obtaining the one or more random access messages may be based on outputting the one or more reference signals.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access resource allocation based on uplink power in accordance with one or more aspects of the present disclosure.

FIG. 2 shows an example of a wireless communications system that supports random access resource allocation based on uplink power in accordance with one or more aspects of the present disclosure.

FIG. 3 shows examples of resource configuration schemes that support random access resource allocation based on uplink power in accordance with one or more aspects of the present disclosure.

FIG. 4 shows an example of a process flow that supports random access resource allocation based on uplink power in accordance with one or more aspects of the present disclosure.

FIGS. 5 and 6 show block diagrams of devices that support random access resource allocation based on uplink power in accordance with one or more aspects of the present disclosure.

FIG. 7 shows a block diagram of a communications manager that supports random access resource allocation based on uplink power in accordance with one or more aspects of the present disclosure.

FIG. 8 shows a diagram of a system including a device that supports random access resource allocation based on uplink power in accordance with one or more aspects of the present disclosure.

FIGS. 9 and 10 show block diagrams of devices that support random access resource allocation based on uplink power in accordance with one or more aspects of the present disclosure.

FIG. 11 shows a block diagram of a communications manager that supports random access resource allocation based on uplink power in accordance with one or more aspects of the present disclosure.

FIG. 12 shows a diagram of a system including a device that supports random access resource allocation based on uplink power in accordance with one or more aspects of the present disclosure.

FIGS. 13 through 16 show flowcharts illustrating methods that support random access resource allocation based on uplink power in accordance with one or more aspects of the present disclosure.

### DETAILED DESCRIPTION

In some wireless communication systems, a user equipment (UE) may select (e.g., randomly select) a preamble to use for transmitting a first message (e.g., Msg 1) in a random access channel (RACH) procedure (e.g., a physical RACH (PRACH) procedure, a four-step PRACH procedure, a two-step PRACH procedure). In some cases, however, the preamble selection may not account for various UE capabilities, various geographical conditions, or environmental conditions of each UE. For instance, some UEs may be associated with reduced capabilities (e.g., reduced transmit power, reduce capability (RedCap) UEs) or may be located far from a network entity relative to other UEs associated with the network entity. Thus, in some cases, a transmission from a first UE (e.g., a UE relatively nearby a network entity) may interfere with (e.g., dominate, overpower) a transmission from a second UE (e.g., a UE relatively far away from the network entity). In such cases, a network entity may fail to receive transmissions from the second UE due to the interference from the first UE. As such, a wireless communication system may experience reduced communication reliability, increased power consumption, and increased signaling overhead, among other effects.

In accordance with one or more aspects described herein, a network entity may configure (e.g., allocate, divide, split) multiple sets of RACH resources based on respective ranges of uplink received power (ULRP) values (e.g., target uplink power values, target ULRP values, uplink transmit power values). For example, the network entity may configure each RACH resource set to be associated with a respective range of targeted uplink power values. In some examples, a UE may receive the RACH resource set configuration and may select a RACH resource set (e.g., RACH preamble selection) based on an uplink power value estimated (e.g., measured, calculated, determined) by the UE. As such, one or more UEs (e.g., low uplink power UEs) may transmit one or more RACH messages in accordance with RACH resources that are allocated for a given uplink power, thus reducing a probability of interfering with other UEs (e.g., high uplink power UEs).

In some examples, the network entity may associate (e.g., allocate) each RACH resource set with one or more RACH occasions (ROs), such that UEs with similar capabilities (e.g., have similar target ULRP) perform RACH transmissions using one or more same ROs. Additionally, or alternatively, the network entity may associate each RACH resource set with a given RACH format, and UEs with similar capabilities may perform RACH transmissions in accordance with a same format. Thus, by utilizing one or more techniques described herein, a wireless communication system may experience improved spectral efficiency, reduced power consumption, improved communication reliability, and other benefits.

Aspects of the disclosure are initially described in the context of wireless communications systems. Aspects of the disclosure are further illustrated by and described with reference to resource configuration schemes, process flows, apparatus diagrams, system diagrams, and flowcharts that relate to random access resource allocation based on uplink power.

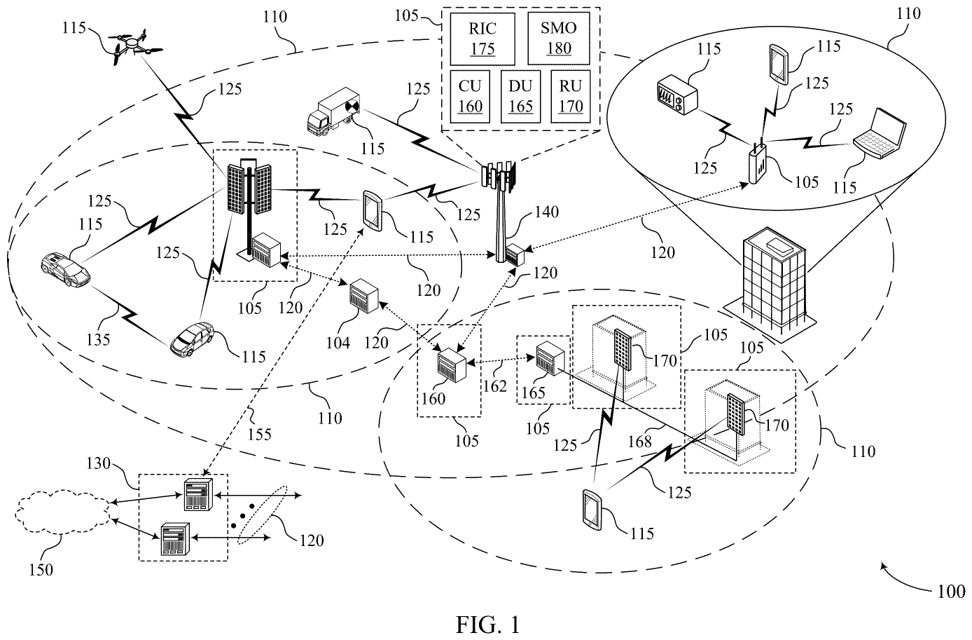

FIG. 1 shows an example of a wireless communications system 100 that supports random access resource allocation based on uplink power in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support random access resource allocation based on uplink power as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions.

Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/|Δfₘₐₓ⋅N_{f}| seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may select a preamble to include with a first random access message (e.g., Msg 1) in a PRACH procedure (e.g., a four-step PRACH procedure, a two-step PRACH procedure). In some cases, however, the preamble selection may not account for various UE capabilities, various geographical conditions, or environmental conditions of each UE. Thus, in some cases, a transmission from a first UE (e.g., a UE relatively nearby a network entity) may interfere with (e.g., dominate, overpower) a transmission from a second UE (e.g., a UE relatively far away from the network entity), resulting in reduced communication reliability, increased power consumption, and increased signaling overhead in the wireless communication system 100.

In accordance with one or more techniques herein, a network entity 105 may configure (e.g., allocate, divide, split) multiple sets of RACH resources (e.g., PRACH resources) based on respective ranges of ULRP values. For example, the network entity 105 may configure each RACH resource set to be associated with a respective range of targeted ULPR values. In some examples, a UE 115 may receive the RACH resource set configuration and may select a RACH resource set (e.g., a RACH preamble) based on an ULRP estimated by the UE 115. Accordingly, one or more UEs 115 (e.g., low uplink power UEs) may transmit RACH messages using RACH resources that are allocated for a given uplink power, thereby reducing a probability of interfering with other UEs 115 (e.g., high uplink power UEs). In some examples, the network entity 105 may allocate RACH resource sets with one or more respective ROs or may associate each RACH resource set with a given RACH format, or both. Thus, by utilizing one or more techniques described herein, a wireless communication system 100 may experience improved spectral efficiency, reduced power consumption, improved communication reliability, and other benefits.

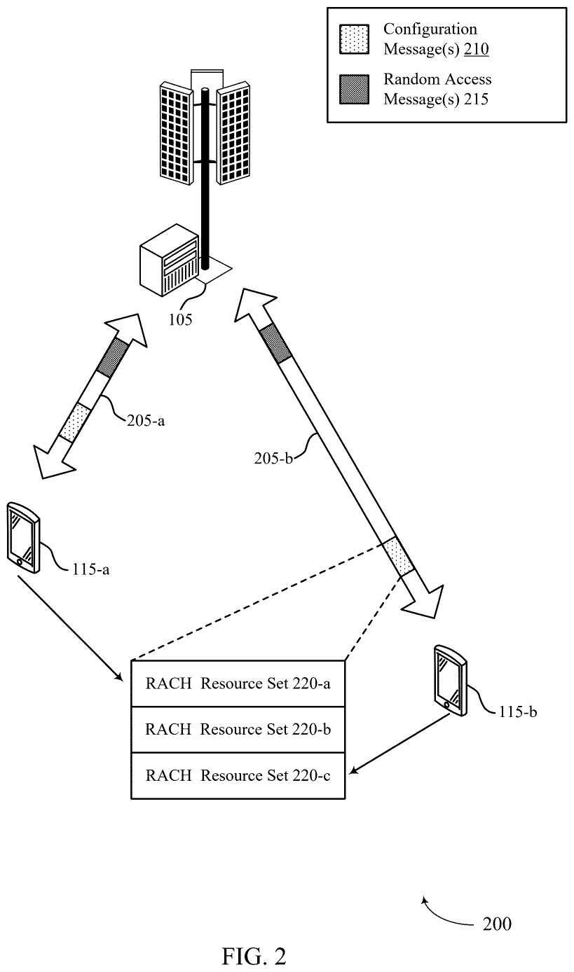

FIG. 2 shows an example of a wireless communications system 200 that supports random access resource allocation based on uplink power in accordance with one or more aspects of the present disclosure. The wireless communications system 200 may implement or be implemented by aspects of the wireless communications system 100 as described with reference to FIG. 1. For example, the wireless communications system 200 may include a network entity 105, a UE 115-a, and a UE 115-b, which may be examples of corresponding devices described herein (e.g., one or more network entities 105, one or more UEs 115, or other devices), including with reference to FIG. 1. The network entity 105 may communicate with the UE 115-a via a communication link 205-a and may communication with the UE 115-b via a communication link 205-b. The communication links 205 may be examples of or include downlink communication interfaces, uplink communication interfaces, or other communication interfaces.

Although a network entity 105 and UEs 115 are shown as example devices of the wireless communications system 200, the techniques herein may be applied by one or more other devices described herein, including with reference to FIG. 1.

In some cases, the wireless communications system 200 may support one or more random access procedures (e.g., PRACH procedures, four-step PRACH, two-step PRACH). For instance, for a transmission of a first random access message 215 (e.g., a Msg 1, an NR Msg 1 transmission in PRACH), each UE 115 may select (e.g., pick, determine) a preamble from a set of preambles allocate by the network entity 105 and may transmit the first random access message 215 (e.g., the Msg 1) in accordance with (e.g., including) the selected preamble. In some cases, the preamble selection at a UE 115 may be random and may not account for (e.g., be optimized for) a performance of the UE 115, a capability of the UE 115, or other dynamic conditions associated with the UE 115. For example, some PRACH procedures (e.g., preamble selection) may assume that each UE 115 performs open loop power control or closed loop power control for PRACH transmission, such that the received PRACH power (e.g., the ULRP) at network entity 105 is relatively similar (e.g., across each UE 115). However, such methods may not consider (e.g., account for) one or more transmit power constraints of a UE 115 (e.g., a transmit power limit, environmental conditions, UE capabilities, and other limitations). As such, it may be possible for a UE 115 (e.g., a UE 115 with a relatively large pathloss), the received PRACH power may not reach the target For instance, a UE 115-b (e.g., a UE 115 that is relatively far away from the network entity 105, a UE 115 that is outside a threshold distance from the network entity 105, a low power UE, a RedCap UE, an IoT UE) and a UE 115-a (e.g., a UE 115 that is relatively nearby the network entity 105, a UE 115 that is within a threshold distance from the network entity 105) may both transmit a random access message 215 in a same RO (e.g., and with different roots, such as Zadoff-Chu (ZC) roots). In some cases, the UE 115-b may be associated with one or more power constraints (e.g., may not be able to apply a sufficient power ramp), and a targeted ULP may be relatively lower for the UE 115-b (e.g., far away UEs) than the UE 115-a (e.g., nearby UEs). For instance, the random access message 215 (e.g., a PRACH message) from the UE 115-b may be received with a relatively lower ULPR value than the random access message 215 from the UE 115-a. As such, interference from the transmission by UE 115-a may dominate (e.g., overpower) the received power (e.g., the ULRP) from the UE 115-b, and the random access message 215 (e.g., the Msg 1, or other messages) from the UE 115-b may be received at the network entity 105.

In some cases, various PRACH formats may be used to support relatively higher repetitions for some UEs 115 (e.g., a UE 115-b, low power coverage extension UEs) and relatively lower repetitions for other UEs (e.g., a UE 115-a, nearby UEs).

However, such methods may not address challenges associated with interference between UEs 115 (e.g., from a high power UE to a low power UE) and may not efficiently divide PRACH resource (e.g., in a frequency domain, FDM resources).

Accordingly, the UE 115-a and the UE 115-b may interfere with each other during a random access procedure, which may result in reduced communication reliability, increased power consumption, and increased signaling overhead in the wireless communications system 200.

In accordance with various techniques described herein, the wireless communications system 200 may support mechanisms or procedures to configure one or more RACH resource sets 220 that are associated with respective ranges of ULRP values. For example, the wireless communications system 200 may support a general preamble selection procedure at a UE 115 based on a configuration (e.g., a splitting, an allocation) of the PRACH resources into one or more sets (e.g., one or more RACH resource sets 220). Accordingly, each UE 115 may select a preamble from a particular RACH resource set 220 based on a targeted UL received power estimated by the UE 115.

In some examples, the network entity 105 may configure (e.g., provide, allocate) one or more RACH resource sets 220 (e.g., PRACH resource sets, random access resource set) for one or more UEs 115. Each RACH resource set 220 may be associated with a respective range of targeted uplink power values. For example, the network entity 105 may configure a RACH resource set 220-a with a first range of values, a RACH resource set 220-b with a second range of uplink power values, and a RACH resource set 220-c with a third range of uplink power values. In some examples, the network entity 105 may transmit one or more configuration messages 210 to one or more UEs 115, which may indicate the RACH resource sets 220. Accordingly, a UE 115 may receive the configuration message 210 and may select a RACH resource set 220 to use based on a targeted ULRP (e.g., at the network entity 105, estimated by the UE 115). In some examples, a UE 115 may determine (e.g., estimate, calculate, compute, measure) an ULRP based on measuring a downlink reference signal received power (RSRP) from one or more reference signals transmitted by the network entity 105. For example, the UE 115 may determine the ULRP (e.g., the predicted ULRP, the targeted ULRP) based on a function of its own transmit power (e.g., its known transmit power) and the measured downlink RSRP.

In some examples, a RACH resource set 220 may include an indication of one or more frequency domain resources or parameters, one or more time domain resources or parameters, one or more spatial domain resources or parameters, a RACH format type, or any combination thereof, which may be used by a UE 115 for transmitting one or more random access messages 215 (e.g., a Msg 1 or other messages as part of a PRACH procedure). In some examples, each of the one or more RACH resource sets 220 may be different from each other based on being associated with at least one of a different PRACH format, different time resources, different frequency resources, or some other parameter difference. In some examples, the network entity 105 may transmit (e.g., via the configuration message 210) an indication of a mapping between one or more RACH resources sets 220 and one or more ranges of targeted uplink power values.

Various techniques may be used to configure the one or more RACH resource sets 220 (e.g., to split the PRACH resources into multiple resource sets) to be associated with respects ranges of targeted uplink power values. For example, the network entity 105 may perform PRACH resource splitting based on PRACH ROs.

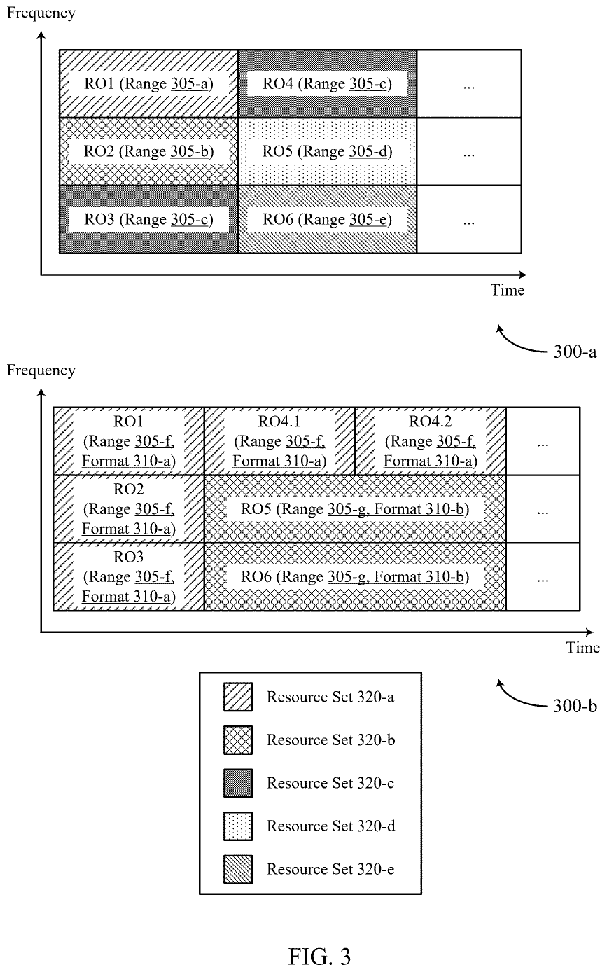

That is, the network entity 105 may allocate a given quantity of ROs to each range of targeted uplink power values. Additionally, or alternatively, the network entity 105 may perform PRACH resource splitting based on PRACH format. That is, the network entity 105 may allocate a given PRACH format to each range of targeted uplink power values. Such techniques may be described in greater detail herein, including with reference to FIG. 3.

Accordingly, each UE 115 may select a RACH resource set 220 (e.g., for performing one or more random access procedures) based on its respective targeted uplink power value. For example, the UE 115-a may be associated with a first targeted uplink power value and the UE 115-b may be associated with a second targeted uplink power value (e.g., lower than the first targeted uplink power value). Based on receiving the one or more configuration messages 210 each UE 115 may select a different RACH resource set 220. That is, the UE 115-a may select a RACH resource set 220-a and the UE 115-b may select a RACH resource set 220-c based on their respective uplink power values. Thus, the UE 115-b may mitigate interference with the UE 115-a when transmitting one or more random access messages 215, which may increase a probability that random access message 215 transmitted by UE 115-b is successfully received at the network entity 105.

FIG. 3 shows examples of resource configuration schemes 300 that support random access resource allocation based on uplink power in accordance with one or more aspects of the present disclosure. The resource configuration schemes 300 may implement or be implemented by aspects of the wireless communications system 100 and the wireless communications system 200 as described with reference to FIGS. 1 and 2. For example, a network entity 105 or a UE 115 may support random access resource configurations in accordance with a resource configuration scheme 300-a, a resource configuration scheme 300-b, or a combination thereof.

In some examples, the resource configuration schemes 300, or one or more aspects thereof, may be communicated between a network entity 105 and a UE 115 (e.g., via one or more configuration messages 210). The horizontal axis of the resource configuration schemes 300 may represent time domain resources and the vertical axis of the resource configuration scheme 300 may represent frequency domain resources.

Although the resource configuration scheme 300-a and the resource configuration scheme 300-b are shown as non-limiting examples, other resource configurations may be implemented by the network entity 105 or the UE 115, including with various quantities of ROs, ranges 305, formats 310, and resource sets 320. For example, the described techniques of the resource configuration scheme 300-a and the resource configuration scheme 300-b may be extended to cover additional time resources, or additional frequency resources, or both.

In some examples, the resource configuration scheme 300-a may illustrate an example of a RACH resource configuration (e.g., PRACH resource splitting) based on PRACH ROs. For example, a network entity 105 may divide (e.g., separate, allocate) PRACH resources into multiple resource sets 320 (e.g., RACH resource sets 220, PRACH resource sets), and each resource set 320 may be associated with (e.g., correspond to) a given range 305 and may occupy a given quantity ROs. For example, a resource set 320-a may be associated with one or more first ROs (e.g., RO1), a resource set 320-b may be associated with one or more second ROs (e.g., RO2), a resource set 320-c may be associated with one or more third ROs (e.g., RO3 and RO4), a resource set 320-d may be associated with one or more fourth ROs (e.g., RO5), and a resource set 320-e may be associated with one or more fifth ROs (e.g., RO6).

Each range 305 may be associated with a range of targeted uplink power values (e.g., ULRP values). For example, a range 305-a may be associated with a first range of uplink power values (e.g., ULRP >−40 decibel-milliwatts (dBm)), a range 305-b may be associated with a second range of uplink power values (e.g.,-60 dBm<ULRP<−40 dBm), a range 305-c may be associated with a third range of uplink power values (e.g., −80 dBm<ULRP<−60 dBm), a range 305-d may be associated with a fourth range of uplink power values (e.g., −100 dBm<ULRP<−80 dBm), and), and a range 305-e may be associated with a fifth range of uplink power values (e.g., −120 dBm<ULRP<−100 dBm). Accordingly, each resource set 320 may be associated with one or more given ROs and with a range 305 of ULRP values (e.g., the resource set 320-a may be associated with RO1 and with the range 305-a).

In some examples, the network entity 105 may configure the multiple resource sets 320 and may indicate a corresponding range 305 of targeted ULRP levels (e.g., values) for each resource set 320. Moreover, one or more preambles in each resource set 320 (e.g., different sets) may differ by ROs (e.g., preambles of resource set 320-a may differ from preambles of resource set 320-b), and one or more preambles within a same set may span across multiple ROs (e.g., RO3 and RO4 for the resource set 230-c). In some examples, the network entity 105 may dynamically map the preamble sets to each RO based on incoming traffic, based on a distribution of one or more UEs 115 in a cell associated with the network entity 105, or both.

Accordingly, based on the targeted ULRP, a UE 115 may select a PRACH preamble from the allocated set (e.g., from the multiple configured resource sets 320). As an illustrative example, if a UE 115 has a ULRP that is within the range 305-d (e.g., −90 dBm) then the UE 115 may select a random preamble from the resource set 320-d (e.g., from RO5). As another example, if a UE 115 has a ULRP that is within the range 305-c (e.g., −70 dBm), the UE 115 may select a random preamble from the resource set 320-c (e.g., from one of RO3 or RO4). Thus, as different UEs 115 (e.g., associated with different pathloss) select the different ROs for random access message transmission (e.g., Msg 1), detection of relatively low ULRP UEs (e.g., weak SNR UEs) may be improved at the network entity 105, and interference from relatively high ULRP UEs (e.g., strong SNR UEs) to low ULRP UEs may be reduced.

In some examples, the resource configuration scheme 300-b may illustrate an example of a RACH resource configuration (e.g., PRACH resource splitting) based on PRACH format. For example, the network entity 105 may divide (e.g., separate, allocate) PRACH resources into multiple resource set 320, and each resource set 320 may be associated with (e.g., correspond to) a given format 310 (e.g., a PRACH format, a RACH format). Each format 310 may be associated with one or more respective parameters for transmitting a random access message, such as a respective quantity of repetitions for repeating a transmission of a random access message (e.g., Msg 1 repetitions, before identifying a failure of a RACH procedure).

In some examples, a network entity 105 may configure (e.g., allocate) a given quantity of ROs for each format 310. For example, the network entity 105 may configure a format 310-a with a first quantity of ROs (e.g., RO1, RO2, RO3, and RO4) and may configure a format 310-b with a second quantity of ROs (e.g., RO5 and RO6). In some examples, the network entity 105 may vary the allocation dynamically based on incoming communication traffic (e.g., from one or more UEs 115). In some examples, one or more ROs that are multiplexed the frequency domain (e.g., FDM ROs, RO1) may use a same format 310 to maintain an equal quantity of time domain symbols.

Additionally, or alternatively, each multiplexed RO (e.g., each FDM RO) may be divided (e.g., split) into multiple ROs in the time domain such that a total quantity of time domain symbols across multiple multiplexed ROs (e.g., multiple FDM ROs) remain the same.

For example, RO1, RO2, and RO3 (e.g., multiplexed ROs) may use a format 310-a (e.g., a PRACH format A1, a same format) and may each occupy a first quantity of time domain symbols (e.g., two symbols). Moreover, an RO4 may use the format 310-a and may occupy a second quantity of time domain symbols (e.g., four symbols). In some examples, RO4 may be divided into one or more relatively smaller ROs (e.g., RO4.1 and RO4.2) that occupy the first quantity time domain symbols (e.g., two symbols) based on being associated with the format 310-a (e.g., the same format as RO1, RO2, and RO3). Further, RO5 and RO6 may use a format 310-b (e.g., PRACH format A2, a different formant than RO1 through RO4) and may each occupy the second quantity of time domain symbols (e.g., four symbols). In the non-limiting example of the resource configuration scheme 300-b, RO1, RO2, RO3, RO4.1, and RO4.2 may be associated with the format 310-a, which may correspond to a resource set 320-a, and RO5 and RO6 may be associated with the format 310-b, which may correspond to a resource set 320-b.

In some examples, a UE 115 may select a format 310 (e.g., and a quantity of repetitions) for transmission of one or more messages based on a targeted ULRP determined by the UE 115 (e.g., based on which range 305 contains its estimated ULRP value). As such, the UE 115 may transmit a PRACH preamble (e.g., a random access message 215) from the selected resource set 320. In some examples, the network entity 105 may configure the UE 115 (e.g., based on transmitting one or more indications) with a mapping between each range 305 of targeted ULRP values to each format 310 (e.g., different preamble formats). For example, if a UE 115 determines a first ULRP value (e.g., −60 dBm) that is contained within a range 305-f (e.g., ULRP>−80 dBm), the UE 115 may select a preamble (e.g., any preamble) from the resource set 320-a (e.g., from one of RO1, RO2, RO3, RO4.1, or RO4.2). If a UE 115 determines a second ULRP value (e.g., −100 dBm) that is contained within a range 305-g (e.g., −120dBm<ULRP<−80 dBm), the UE 115 may select a preamble (e.g., any preamble) from the resource set 320-b (e.g., from one of RO5 or RO6).

As such, a selection of format 310 based on targeted ULRP values may enable UEs associated with relatively low ULRP values (e.g., relatively weak SNR UEs) to transmit with a greater quantity of repetitions compared to UEs with relatively higher ULRP values (e.g., relatively strong SNR UEs), which may improve PRACH detection performance. Moreover, the selection of format 310 may enable the network entity 105 to allocate a higher quantity of total preambles across different formats 310 for a given set of time resources and frequency resources, thus mitigating preamble collision (e.g., during PRACH procedures).

In some examples, a network entity 105 may also configure one or more resource sets 320 in accordance with some combination of the resource configuration scheme 300-a and the resource configuration scheme 300-b. For example, a UE 115 may select a preamble from the resource set 320 that satisfies one or more conditions of each scheme. In some examples, the resource configuration schemes 300 may be applicable for both contention based random access (CBRA) and contention free random access (CFRA) based procedures. For example, in a CFRA based procedure, the network entity 105 may allocate a fixed preamble for a UE 115 in each resource set 320, and the UE 115 (e.g., based on targeted ULRP) may select a resource set 320 and may transmit the allocated preamble in that resource set 320.

In some examples, a UE 115 may dynamically switch between resource sets 320. For example, the UE 115 may pick a resource set 320 based on its targeted ULRP (e.g., the UE 115 may estimate its targeted ULRP either through open loop power control or closed loop power control) and may use the selected resource set 320 for one or more subsequent PRACH transmissions. The UE may then switch the selected resource set 320 based on various techniques. For example, the UE 115 may switch to another resource set 320 if the UE 115 detects a change in the targeted ULRP (e.g., either via open loop power control or closed loop power control). Additionally, or alternatively, the UE 115 may switch to another resource set 320 if one or more transmissions (e.g., Msg 1 transmissions) from a currently selected resource set 320 fails (e.g., and the UE 115 used open loop power control to estimate targeted ULRP). In some examples, the UE 115 may use a quantity of access attempts configured by the network entity 105 (e.g., one or more sequences of access attempts in each resource set 320). In some examples, a UE 115 may switch to a resource set 320 with a lower targeted ULRP value (e.g., a range 305 that includes relatively lower ULRP values) based on (e.g., in response to) a failed transmission of a first random access message (e.g., in the case of failed Msg 1 attempt).

Thus, a UE 115 may be enabled to increase communication reliability in a wireless communication system by increasing a probability of successful transmission of random access messages. For example, by selecting resources sets 320 based on a targeted ULRP value, UEs 115 that are associated with relatively higher ULRP values may use different resources for communicating with a network entity 105 than other UEs associated with relatively lower ULRP values, thus mitigating channel interference effects. Accordingly, by applying one or more aspects described herein, a wireless communications system may operate with increased reliability, improved communication quality, reduced power consumption, and improved user experience.

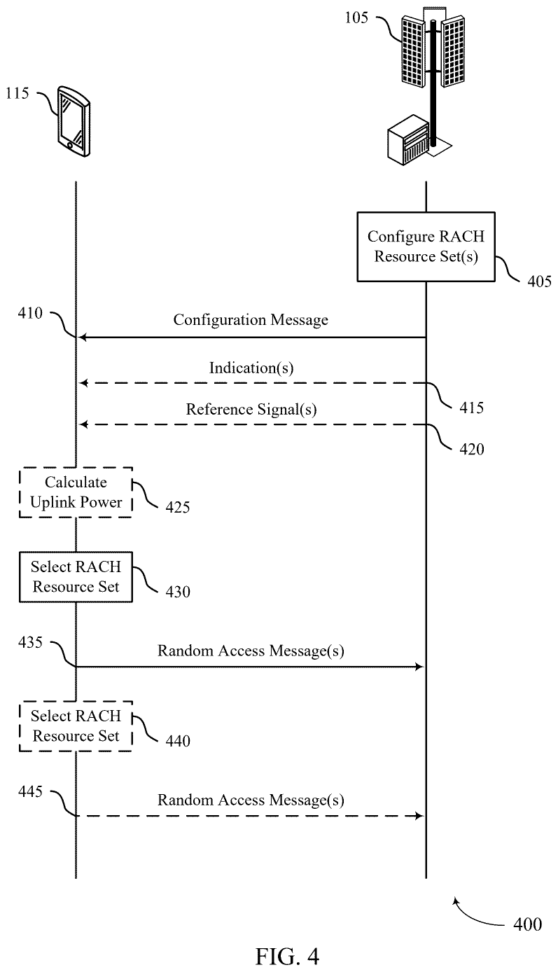

FIG. 4 shows an example of a process flow 400 that supports random access resource allocation based on uplink power in accordance with one or more aspects of the present disclosure. The process flow 400 may implement or be implemented to realize aspects of the wireless communications system 100, the wireless communications system 200, or the resource configuration schemes 300. For example, the process flow 400 illustrates communication between a UE 115 and a network entity 105, which may be examples of corresponding devices described herein. Alternative examples of the following may be implemented. Some steps are performed in a different order than described or are not performed at all. In some implementations, steps may include additional features not mentioned below, or further steps may be added. Further, although the UE 115 and the network entity 105 are shown performing the operations of the process flow 400, some aspects of some operations may also be performed by one or more other wireless communication devices (such as by multiple network entities 105, or in accordance with coordination among multiple network entities 105).

At 405, the network entity 105 may configure one or more RACH resource sets (e.g., RACH resource sets 220, resource sets 320). In some examples, each RACH resource set may be associated with a respective range (e.g., range 305) of targeted uplink power values (e.g., ULRP values). In some examples, the network entity 105 may allocate a respective quantity of ROs to each RACH resource set, and one or more random access messages (e.g., random access messages 215, Msg 1) may be obtained (e.g., received) by the network entity 105 in accordance with an RO associated with a RACH resource set selected by the UE 115. Additionally, or alternatively, the network entity 105 may allocate a respective set of random access preambles to each RACH resource set. In such examples, one or more random access messages may be obtained in accordance with a preamble associated with a RACH resource set selected by the UE 115.

Additionally, or alternatively, the network entity 105 may allocate a respective RACH format (e.g., a format 310) to each RACH resource set. In such examples, one or more random access messages may be obtained in accordance with a RACH format associated with a RACH resource set selected by the UE 115. For example, the network entity 105 may allocate a first RACH format (e.g., format 310-a) to a first RACH resource set (e.g., resource set 320-a) and may allocate a second RACH format (e.g., format 310-b) different than the first RACH format to a second RACH resource set (e.g., resource set 320-b). In some examples, the network entity 105 may allocate a first RO (e.g., RO4) and a second RO (e.g., RO5) on a same set of time domain resources. The network entity 105 may divide (e.g., separate, allocate, distribute) the first RO into two or more portions (e.g., RO4.1 and RO4.2), and each portion may respectively correspond to the first RACH resource set. In some examples, the second RO may correspond to the second RACH resource set.

At 410, the UE 115 may receive a configuration message (e.g., one or more configuration messages 210) indicating the one or more RACH resource sets for the UE 115. In some examples, the configuration message may be output (e.g., transmitted) by a network entity 105. In some examples, each RACH resource set may be associated with a respective range (e.g., a range 305) of targeted uplink power values (e.g., ULRP values). In some examples, each RACH resource set may be associated with a respective quantity of ROs. In some examples, each RACH resource set may be associated with a unique plurality of random access preambles.

Additionally, or alternatively, each RACH resource set may be associated with a respective RACH format. In some examples, a first RO may include two or more portions, where each of the two or more portions may respectively correspond to a first RACH resource set associated with a first RACH format. Additionally, a second RO may include a single portion that corresponds to a second RACH resource set associated with a second RACH format different than the first RACH format. In some examples, the first RO and the second RO may occupy a same set of time domain resources. In some examples, a first RACH format may be associated with a first quantity of repetitions (e.g., for repeating a transmission of a random access message) and a second RACH format may be associated with a second quantity of repetitions that is greater than the first quantity. In some examples, one or more first targeted uplink power values of a first range associated with the first RACH format may be greater than one or more second targeted uplink power values of a second range associated with the second RACH format.

At 415, in some examples, the UE 115 may receive one or more indications (e.g., indications associated with the RACH resource sets, associated with the configuration message), which may be output by the network entity 105. For example, the UE 115 may receive an indication of a mapping between each range of targeted uplink power values and each RACH resource set. In some examples, the UE 115 may select a RACH resource set based on the indication of the mapping. Additionally, or alternatively, the UE 115 may receive an indication to use the uplink power value associated with the UE 115 for selecting the RACH resource set (e.g., the network entity 105 may enable the ULRP-based selection mechanism at the UE 115), and the UE 115 may select the RACH resource set based on receiving indication. In some examples, the one or more indications may be received via the configuration message, separate from the configuration message, or both.

At 420, in some examples, the UE 115 may receive one or more reference signals, which may be output by the network entity 105. For example, the network entity 105 may output one or more reference signals for the UE 115 to perform one or more measurements and determine one or more parameters associated with the reference signals. In some examples, the reference signals may include one or more downlink reference signals.

At 425, in some examples, the UE 115 may calculate an uplink power value (e.g., a targeted ULRP value) used based on an RSRP value measured in accordance with receiving the one or more reference signals. For example, the UE 115 may determine a supported transmit power (e.g., a known transmit power of the UE 115, a transmit power capability) and may calculate the uplink power value based on a function of the supported transmit power and the measured RSRP value (e.g., the downlink RSRP). In some examples, the UE 115 may use the calculated uplink transmit power to select a RACH resource set.

At 430, the UE 115 may select a RACH resource set from the one or more configured RACH resource sets based on an uplink power value associated with the UE 115. In some examples, the UE 115 may select a random access preamble from a set of multiple random access preambles (e.g., from one or more ROs) associated with the selected RACH resource set. Additionally, or alternatively, the UE 115 may select a RACH format associated with the selected RACH resource set. In some examples, one or more random access messages may be transmitted in accordance with a quantity of repetitions in accordance with the selected RACH format. Additionally, or alternatively, At 435, the UE 115 may transmit one or more random access messages (e.g., random access message 215, Msg 1, other messages associated with a RACH procedures) in accordance with one or more resources of the RACH resource set based on selecting the RACH resource set. In some examples, the network entity 105 may obtain (e.g., receive) the one or more random access messages from the UE 115. For example, the one or more random access messages may be transmitted (e.g., and obtained) in accordance with a quantity of repetitions associated with the selected RACH resource set, a random access preamble associated with the selected RACH resource set, or both.

At 440, in some examples, the UE 115 may select another RACH resource set. For example, the UE 115 may detect a change in the uplink power value associated with the UE 115, and the UE 115 may select (e.g., switch from a first RACH resource set to) a second RACH resource set from the one or more configured RACH resource sets. In some examples, the second RACH resource set may be different from the RACH resource set (e.g., the first selected set) based on detecting the change.

Additionally, or alternatively, the UE 115 may select the second RACH resource set f based on one or more failures of the one or more random access messages transmitted by the UE 115.

At 445, in some examples, the UE 115 may transmit one or more second random access messages in accordance with one or more second resources of the RACH resource set, which may be obtained by the network entity 105. In some examples, the UE 115 may transmit the one or more second random access messages based on selecting the second RACH resource set (e.g., based on detecting a change in ULRP, based on one or more failures of the first random access messages).

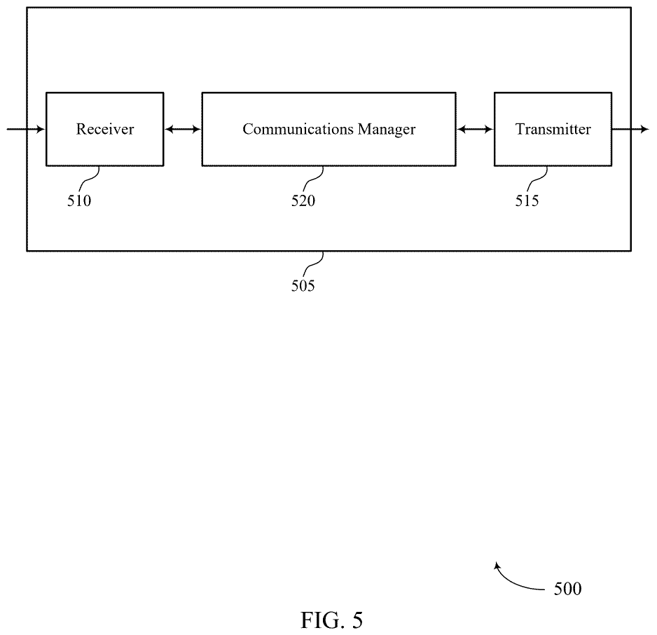

FIG. 5 shows a block diagram 500 of a device 505 that supports random access resource allocation based on uplink power in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques.

Each of these components may be in communication with one another (e.g., via one or more buses).

The receiver 510 may provide a means for receiving information such as packets, user data, control information, or any combination thereof associated with various information channels (e.g., control channels, data channels, information channels related to random access resource allocation based on uplink power).

Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to random access resource allocation based on uplink power). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of random access resource allocation based on uplink power as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a network entity, a configuration message indicating a set of multiple random access channel resource sets for the UE, where each random access channel resource set of the set of multiple random access channel resource sets is associated with a respective range of targeted uplink power values. The communications manager 520 is capable of, configured to, or operable to support a means for selecting a random access channel resource set from the set of multiple random access channel resource sets based on an uplink power value associated with the UE. The communications manager 520 is capable of, configured to, or operable to support a means for transmitting, to the network entity, one or more random access messages in accordance with one or more resources of the random access channel resource set based on selecting the random access channel resource set.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources, among other benefits.

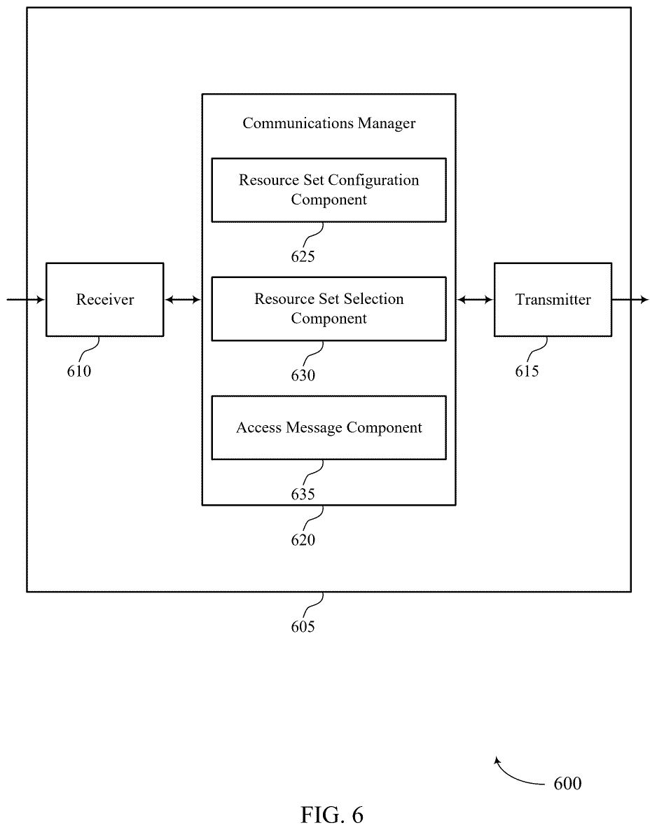

FIG. 6 shows a block diagram 600 of a device 605 that supports random access resource allocation based on uplink power in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to random access resource allocation based on uplink power).

Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to random access resource allocation based on uplink power). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of random access resource allocation based on uplink power as described herein. For example, the communications manager 620 may include a resource set configuration component 625, a resource set selection component 630, an access message component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The resource set configuration component 625 is capable of, configured to, or operable to support a means for receiving, from a network entity, a configuration message indicating a set of multiple random access channel resource sets for the UE, where each random access channel resource set of the set of multiple random access channel resource sets is associated with a respective range of targeted uplink power values. The resource set selection component 630 is capable of, configured to, or operable to support a means for selecting a random access channel resource set from the set of multiple random access channel resource sets based on an uplink power value associated with the UE. The access message component 635 is capable of, configured to, or operable to support a means for transmitting, to the network entity, one or more random access messages in accordance with one or more resources of the random access channel resource set based on selecting the random access channel resource set.

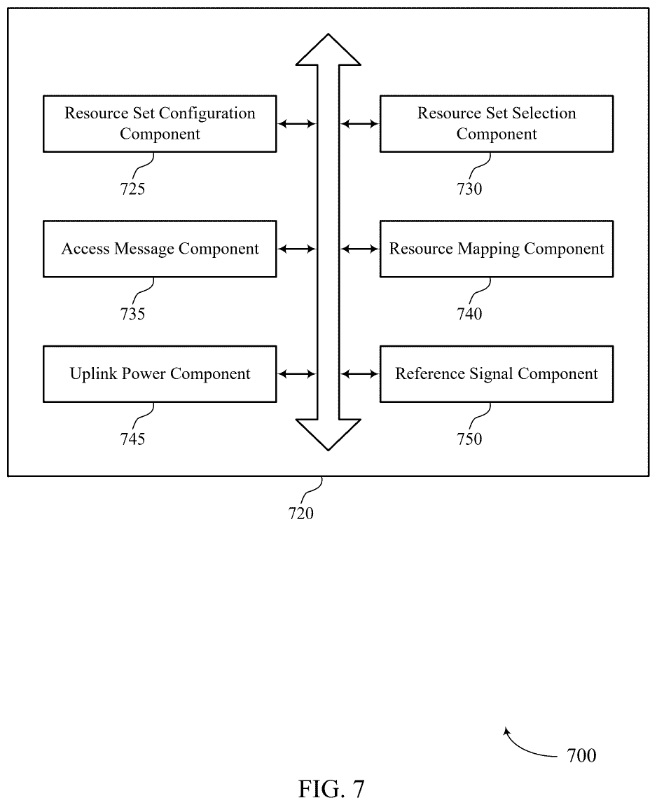

FIG. 7 shows a block diagram 700 of a communications manager 720 that supports random access resource allocation based on uplink power in accordance with one or more aspects of the present disclosure. The communications manager 720 may be an example of aspects of a communications manager 520, a communications manager 620, or both, as described herein. The communications manager 720, or various components thereof, may be an example of means for performing various aspects of random access resource allocation based on uplink power as described herein. For example, the communications manager 720 may include a resource set configuration component 725, a resource set selection component 730, an access message component 735, a resource mapping component 740, an uplink power component 745, a reference signal component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The resource set configuration component 725 is capable of, configured to, or operable to support a means for receiving, from a network entity, a configuration message indicating a set of multiple random access channel resource sets for the UE, where each random access channel resource set of the set of multiple random access channel resource sets is associated with a respective range of targeted uplink power values. The resource set selection component 730 is capable of, configured to, or operable to support a means for selecting a random access channel resource set from the set of multiple random access channel resource sets based on an uplink power value associated with the UE. The access message component 735 is capable of, configured to, or operable to support a means for transmitting, to the network entity, one or more random access messages in accordance with one or more resources of the random access channel resource set based on selecting the random access channel resource set.

In some examples, the resource mapping component 740 is capable of, configured to, or operable to support a means for receiving an indication of a mapping between each range of targeted uplink power values and each random access channel resource set, where selecting the random access channel resource set is based on the indication of the mapping.

In some examples, each random access channel resource set of the set of multiple random access channel resource sets is associated with a respective quantity of random access occasions.

In some examples, to support selecting the random access channel resource set, the resource set selection component 730 is capable of, configured to, or operable to support a means for selecting a random access preamble from a set of multiple random access preambles associated with the selected random access channel resource set.

In some examples, each random access channel resource set of the set of multiple random access channel resource sets is associated with a unique set of multiple random access preambles.

In some examples, each random access channel resource set of the set of multiple random access channel resource sets is associated with a respective random access channel format.

In some examples, a first random access occasion includes two or more portions, each of the two or more portions respectively corresponding to a first random access channel resource set associated with a first random access channel format. In some examples, a second random access occasion includes a single portion that corresponds to a second random access channel resource set associated with a second random access channel format different than the first random access channel format. In some examples, the first random access occasion and the second random access occasion occupy a same set of time domain resources.

In some examples, a first random access channel format is associated with a first quantity of repetitions and a second random access channel format is associated with a second quantity of repetitions that is greater than the first quantity. In some examples, one or more first targeted uplink power values of a first range associated with the first random access channel format are greater than one or more second targeted uplink power values of a second range associated with the second random access channel format.

In some examples, to support selecting the random access channel resource set, the resource set selection component 730 is capable of, configured to, or operable to support a means for selecting a random access channel format associated with the selected random access channel resource set, where the one or more random access messages are transmitted in accordance with a quantity of repetitions in accordance with the selected random access channel format.

In some examples, the uplink power component 745 is capable of, configured to, or operable to support a means for detecting a change in the uplink power value associated with the UE. In some examples, the resource set selection component 730 is capable of, configured to, or operable to support a means for selecting a second random access channel resource set from the set of multiple random access channel resource sets different from the random access channel resource set based on detecting the change. In some examples, the access message component 735 is capable of, configured to, or operable to support a means for transmitting, to the network entity, one or more second random access messages in accordance with one or more second resources of the random access channel resource set based on selecting the second random access channel resource set.

In some examples, the resource set selection component 730 is capable of, configured to, or operable to support a means for selecting a second random access channel resource set from the set of multiple random access channel resource sets different from the random access channel resource set based on one or more failures of the one or more random access messages. In some examples, the access message component 735 is capable of, configured to, or operable to support a means for transmitting, to the network entity, one or more second random access messages in accordance with one or more second resources of the random access channel resource set based on selecting the second random access channel resource set.

In some examples, the resource set selection component 730 is capable of, configured to, or operable to support a means for receiving an indication to use the uplink power value associated with the UE for selecting the random access channel resource set, where the selecting is based on receiving the indication.

In some examples, the reference signal component 750 is capable of, configured to, or operable to support a means for receiving one or more reference signals from the network entity. In some examples, the uplink power component 745 is capable of, configured to, or operable to support a means for calculating the uplink power value used based on an RSRP value measured in accordance with receiving the one or more reference signals.

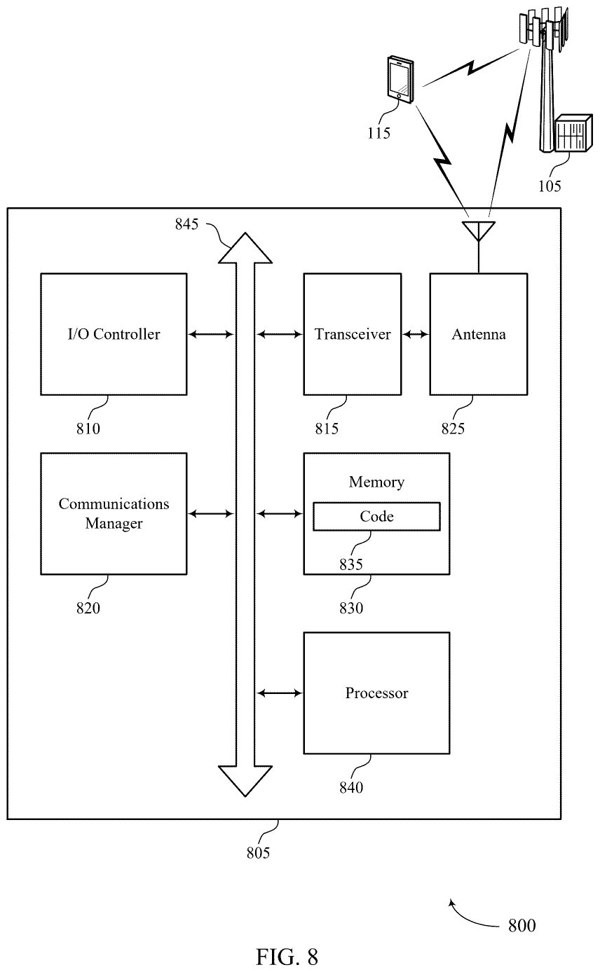

FIG. 8 shows a diagram of a system 800 including a device 805 that supports random access resource allocation based on uplink power in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting random access resource allocation based on uplink power). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving, from a network entity, a configuration message indicating a set of multiple random access channel resource sets for the UE, where each random access channel resource set of the set of multiple random access channel resource sets is associated with a respective range of targeted uplink power values. The communications manager 820 is capable of, configured to, or operable to support a means for selecting a random access channel resource set from the set of multiple random access channel resource sets based on an uplink power value associated with the UE. The communications manager 820 is capable of, configured to, or operable to support a means for transmitting, to the network entity, one or more random access messages in accordance with one or more resources of the random access channel resource set based on selecting the random access channel resource set.

By including or configuring the communications manager 820 in accordance with examples as described herein, the device 805 may support techniques for improved communication reliability, reduced latency, reduced power consumption, more efficient utilization of communication resources, improved coordination between devices, and longer battery life, among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of random access resource allocation based on uplink power as described herein, or the at least one processor 840 and the at least one memory 830 may be otherwise configured to, individually or collectively, perform or support such operations.

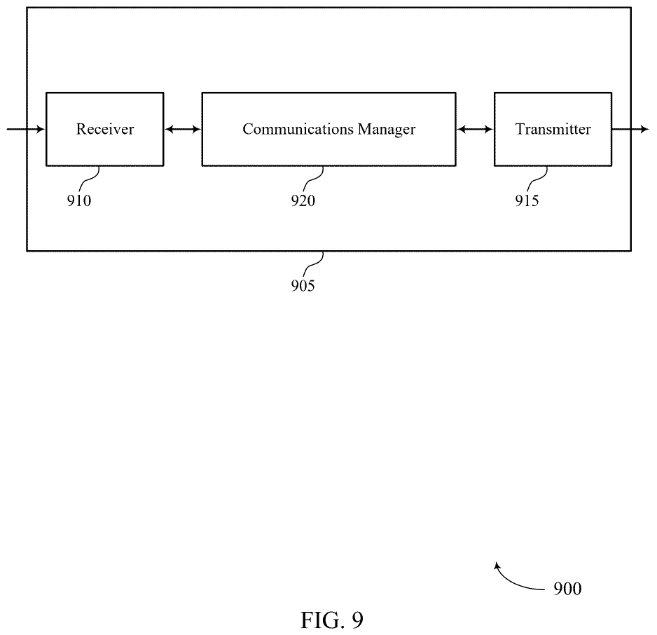

FIG. 9 shows a block diagram 900 of a device 905 that supports random access resource allocation based on uplink power in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of random access resource allocation based on uplink power as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for configuring a set of multiple random access channel resource sets, where each random access channel resource set of the set of multiple random access channel resource sets is associated with a respective range of targeted uplink power values. The communications manager 920 is capable of, configured to, or operable to support a means for outputting, to a UE, a configuration message indicating the set of multiple random access channel resource sets based on configuring the set of multiple random access channel resource sets. The communications manager 920 is capable of, configured to, or operable to support a means for obtaining, from the UE, one or more random access messages in accordance with one or more resources of a random access channel resource set in accordance with an uplink power value associated with the UE.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, and more efficient utilization of communication resources, among other benefits.

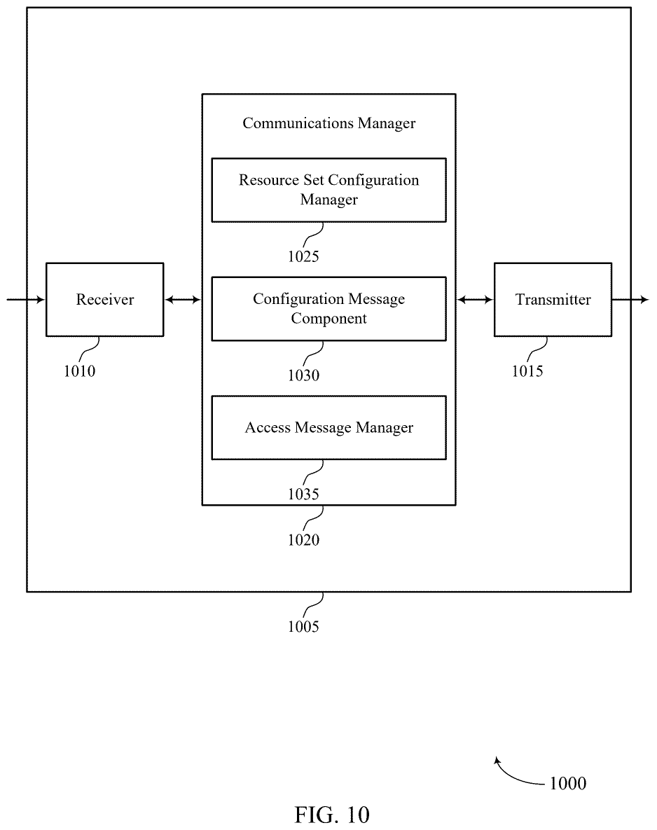

FIG. 10 shows a block diagram 1000 of a device 1005 that supports random access resource allocation based on uplink power in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of random access resource allocation based on uplink power as described herein. For example, the communications manager 1020 may include a resource set configuration manager 1025, a configuration message component 1030, an access message manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The resource set configuration manager 1025 is capable of, configured to, or operable to support a means for configuring a set of multiple random access channel resource sets, where each random access channel resource set of the set of multiple random access channel resource sets is associated with a respective range of targeted uplink power values. The configuration message component 1030 is capable of, configured to, or operable to support a means for outputting, to a UE, a configuration message indicating the set of multiple random access channel resource sets based on configuring the set of multiple random access channel resource sets. The access message manager 1035 is capable of, configured to, or operable to support a means for obtaining, from the UE, one or more random access messages in accordance with one or more resources of a random access channel resource set in accordance with an uplink power value associated with the UE.

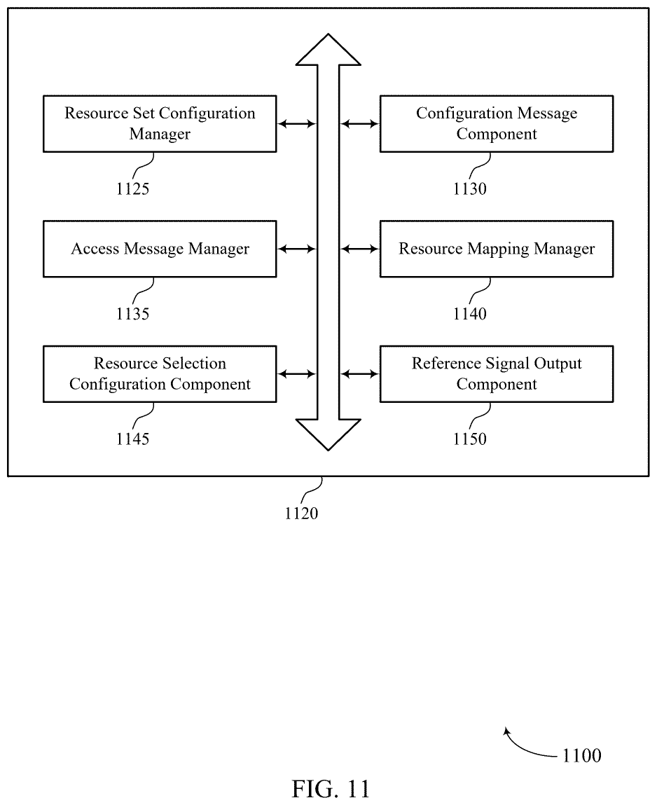

FIG. 11 shows a block diagram 1100 of a communications manager 1120 that supports random access resource allocation based on uplink power in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of random access resource allocation based on uplink power as described herein. For example, the communications manager 1120 may include a resource set configuration manager 1125, a configuration message component 1130, an access message manager 1135, a resource mapping manager 1140, a resource selection configuration component 1145, a reference signal output component 1150, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The resource set configuration manager 1125 is capable of, configured to, or operable to support a means for configuring a set of multiple random access channel resource sets, where each random access channel resource set of the set of multiple random access channel resource sets is associated with a respective range of targeted uplink power values. The configuration message component 1130 is capable of, configured to, or operable to support a means for outputting, to a UE, a configuration message indicating the set of multiple random access channel resource sets based on configuring the set of multiple random access channel resource sets. The access message manager 1135 is capable of, configured to, or operable to support a means for obtaining, from the UE, one or more random access messages in accordance with one or more resources of a random access channel resource set in accordance with an uplink power value associated with the UE.

In some examples, the resource mapping manager 1140 is capable of, configured to, or operable to support a means for outputting an indication of a mapping between each range of targeted uplink power values and each random access channel resource set, where obtaining the one or more random access messages is based on the indication of the mapping.

In some examples, to support configuring the set of multiple random access channel resource sets, the resource set configuration manager 1125 is capable of, configured to, or operable to support a means for allocating a respective quantity of random access occasions to each random access channel resource set of the set of multiple random access channel resource sets, where the one or more random access messages are obtained in accordance with a random access occasion associated with a random access channel resource set selected by the UE.

In some examples, to support configuring the set of multiple random access channel resource sets, the resource set configuration manager 1125 is capable of, configured to, or operable to support a means for allocating a respective set of multiple random access preambles to each random access channel resource set of the set of multiple random access channel resource sets, where the one or more random access messages are obtained in accordance with a preamble associated with a random access channel resource set selected by the UE.

In some examples, to support configuring the set of multiple random access channel resource sets, the resource set configuration manager 1125 is capable of, configured to, or operable to support a means for allocating a respective random access channel format to each random access channel resource set of the set of multiple random access channel resource sets, where the one or more random access messages are obtained in accordance with a random access channel format associated with a random access channel resource set selected by the UE.

In some examples, the resource set configuration manager 1125 is capable of, configured to, or operable to support a means for allocating a first random access channel format to a first random access channel resource set of the set of multiple random access channel resource sets. In some examples, the resource set configuration manager 1125 is capable of, configured to, or operable to support a means for allocating a second random access channel format different than the first random access channel format to a second random access channel resource set of the set of multiple random access channel resource sets. In some examples, the resource set configuration manager 1125 is capable of, configured to, or operable to support a means for allocating a first random access occasion and a second random access occasion on a same set of time domain resources. In some examples, the resource set configuration manager 1125 is capable of, configured to, or operable to support a means for dividing the first random access occasion into two or more portions, each portion respectively corresponding to the first random access channel resource set, where the second random access occasion corresponds to the second random access channel resource set.

In some examples, a first random access channel format is associated with a first quantity of repetitions and a second random access channel format is associated with a second quantity of repetitions that is greater than the first quantity. In some examples, one or more first targeted uplink power values of a first range associated with the first random access channel format are greater than one or more second targeted uplink power values of a second range associated with the second random access channel format.

In some examples, the resource selection configuration component 1145 is capable of, configured to, or operable to support a means for outputting an indication to use the uplink power value associated with the UE for selection of a random access channel resource set, where obtaining the one or more random access messages is based on outputting the indication.

In some examples, the reference signal output component 1150 is capable of, configured to, or operable to support a means for outputting one or more reference signals to the UE, where obtaining the one or more random access messages is based on outputting the one or more reference signals.

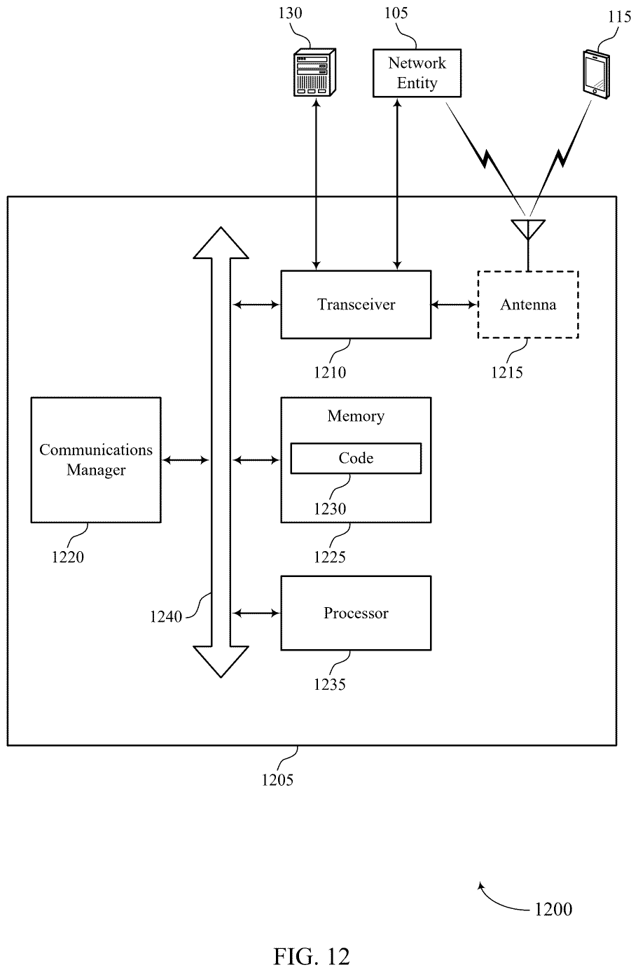

FIG. 12 shows a diagram of a system 1200 including a device 1205 that supports random access resource allocation based on uplink power in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting random access resource allocation based on uplink power). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for configuring a set of multiple random access channel resource sets, where each random access channel resource set of the set of multiple random access channel resource sets is associated with a respective range of targeted uplink power values. The communications manager 1220 is capable of, configured to, or operable to support a means for outputting, to a UE, a configuration message indicating the set of multiple random access channel resource sets based on configuring the set of multiple random access channel resource sets. The communications manager 1220 is capable of, configured to, or operable to support a means for obtaining, from the UE, one or more random access messages in accordance with one or more resources of a random access channel resource set in accordance with an uplink power value associated with the UE.

By including or configuring the communications manager 1220 in accordance with examples as described herein, the device 1205 may support techniques for improved communication reliability, reduced latency, more efficient utilization of communication resources, improved coordination between devices, and improved utilization of processing capability, among other benefits.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of random access resource allocation based on uplink power as described herein, or the at least one processor 1235 and the at least one memory 1225 may be otherwise configured to, individually or collectively, perform or support such operations.

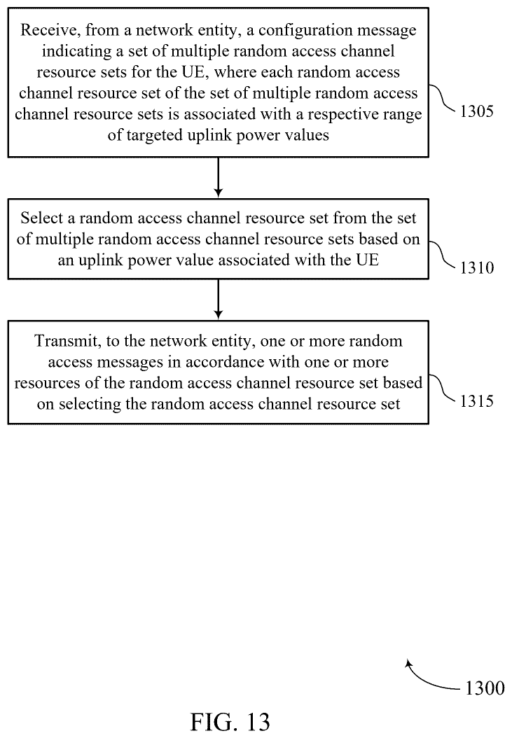

FIG. 13 shows a flowchart illustrating a method 1300 that supports random access resource allocation based on uplink power in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a configuration message indicating a set of multiple random access channel resource sets for the UE, where each random access channel resource set of the set of multiple random access channel resource sets is associated with a respective range of targeted uplink power values. The operations of 1305 may be performed in accordance with examples as disclosed herein. In some examples, aspects of the operations of 1305 may be performed by a resource set configuration component 725 as described with reference to FIG. 7.

At 1310, the method may include selecting a random access channel resource set from the set of multiple random access channel resource sets based on an uplink power value associated with the UE. The operations of 1310 may be performed in accordance with examples as disclosed herein. In some examples, aspects of the operations of 1310 may be performed by a resource set selection component 730 as described with reference to FIG. 7.

At 1315, the method may include transmitting, to the network entity, one or more random access messages in accordance with one or more resources of the random access channel resource set based on selecting the random access channel resource set. The operations of 1315 may be performed in accordance with examples as disclosed herein. In some examples, aspects of the operations of 1315 may be performed by an access message component 735 as described with reference to FIG. 7.

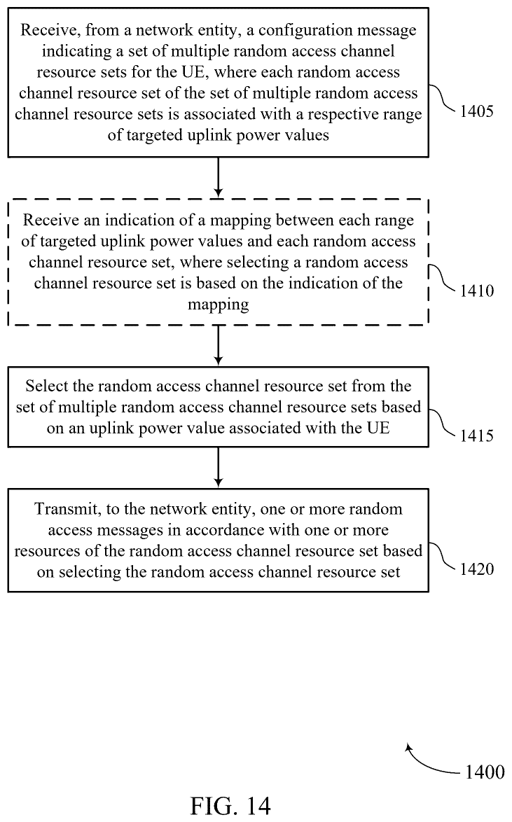

FIG. 14 shows a flowchart illustrating a method 1400 that supports random access resource allocation based on uplink power in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a configuration message indicating a set of multiple random access channel resource sets for the UE, where each random access channel resource set of the set of multiple random access channel resource sets is associated with a respective range of targeted uplink power values. The operations of 1405 may be performed in accordance with examples as disclosed herein. In some examples, aspects of the operations of 1405 may be performed by a resource set configuration component 725 as described with reference to FIG. 7.

At 1410, the method may include receiving an indication of a mapping between each range of targeted uplink power values and each random access channel resource set, where selecting a random access channel resource set is based on the indication of the mapping. The operations of 1410 may be performed in accordance with examples as disclosed herein. In some examples, aspects of the operations of 1410 may be performed by a resource mapping component 740 as described with reference to FIG. 7.

At 1415, the method may include selecting the random access channel resource set from the set of multiple random access channel resource sets based on an uplink power value associated with the UE. The operations of 1415 may be performed in accordance with examples as disclosed herein. In some examples, aspects of the operations of 1415 may be performed by a resource set selection component 730 as described with reference to FIG. 7.

At 1420, the method may include transmitting, to the network entity, one or more random access messages in accordance with one or more resources of the random access channel resource set based on selecting the random access channel resource set. The operations of 1420 may be performed in accordance with examples as disclosed herein. In some examples, aspects of the operations of 1420 may be performed by an access message component 735 as described with reference to FIG. 7.

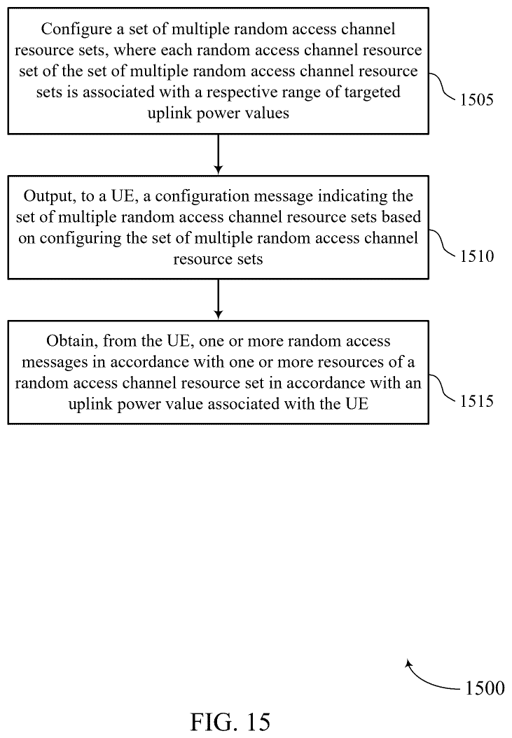

FIG. 15 shows a flowchart illustrating a method 1500 that supports random access resource allocation based on uplink power in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include configuring a set of multiple random access channel resource sets, where each random access channel resource set of the set of multiple random access channel resource sets is associated with a respective range of targeted uplink power values. The operations of 1505 may be performed in accordance with examples as disclosed herein. In some examples, aspects of the operations of 1505 may be performed by a resource set configuration manager 1125 as described with reference to FIG. 11.

At 1510, the method may include outputting, to a UE, a configuration message indicating the set of multiple random access channel resource sets based on configuring the set of multiple random access channel resource sets. The operations of 1510 may be performed in accordance with examples as disclosed herein. In some examples, aspects of the operations of 1510 may be performed by a configuration message component 1130 as described with reference to FIG. 11.

At 1515, the method may include obtaining, from the UE, one or more random access messages in accordance with one or more resources of a random access channel resource set in accordance with an uplink power value associated with the UE. The operations of 1515 may be performed in accordance with examples as disclosed herein. In some examples, aspects of the operations of 1515 may be performed by an access message manager 1135 as described with reference to FIG. 11.

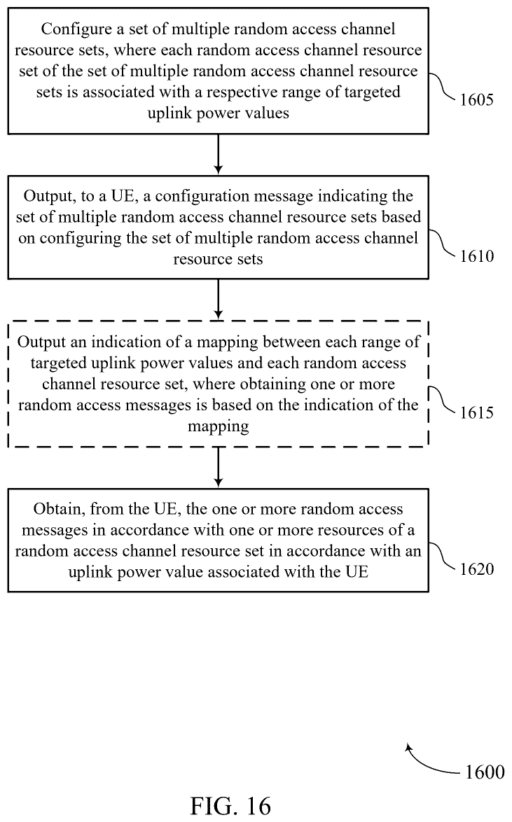

FIG. 16 shows a flowchart illustrating a method 1600 that supports random access resource allocation based on uplink power in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include configuring a set of multiple random access channel resource sets, where each random access channel resource set of the set of multiple random access channel resource sets is associated with a respective range of targeted uplink power values. The operations of 1605 may be performed in accordance with examples as disclosed herein. In some examples, aspects of the operations of 1605 may be performed by a resource set configuration manager 1125 as described with reference to FIG. 11.

At 1610, the method may include outputting, to a UE, a configuration message indicating the set of multiple random access channel resource sets based on configuring the set of multiple random access channel resource sets. The operations of 1610 may be performed in accordance with examples as disclosed herein. In some examples, aspects of the operations of 1610 may be performed by a configuration message component 1130 as described with reference to FIG. 11.

At 1615, the method may include outputting an indication of a mapping between each range of targeted uplink power values and each random access channel resource set, where obtaining one or more random access messages is based on the indication of the mapping. The operations of 1615 may be performed in accordance with examples as disclosed herein. In some examples, aspects of the operations of 1615 may be performed by a resource mapping manager 1140 as described with reference to FIG. 11.

At 1620, the method may include obtaining, from the UE, the one or more random access messages in accordance with one or more resources of a random access channel resource set in accordance with an uplink power value associated with the UE. The operations of 1620 may be performed in accordance with examples as disclosed herein. In some examples, aspects of the operations of 1620 may be performed by an access message manager 1135 as described with reference to FIG. 11.

The following provides an overview of aspects of the present disclosure:

Aspect 1: A method for wireless communications by a UE, comprising: receiving, from a network entity, a configuration message indicating a plurality of random access channel resource sets for the UE, wherein each random access channel resource set of the plurality of random access channel resource sets is associated with a respective range of targeted uplink power values; selecting a random access channel resource set from the plurality of random access channel resource sets based at least in part on an uplink power value associated with the UE; and transmitting, to the network entity, one or more random access messages in accordance with one or more resources of the random access channel resource set based at least in part on selecting the random access channel resource set.

Aspect 2: The method of aspect 1, further comprising: receiving an indication of a mapping between each range of targeted uplink power values and each random access channel resource set, wherein selecting the random access channel resource set is based at least in part on the indication of the mapping.

Aspect 3: The method of any of aspects 1 through 2, wherein each random access channel resource set of the plurality of random access channel resource sets is associated with a respective quantity of random access occasions.

Aspect 4: The method of any of aspects 1 through 3, wherein selecting the random access channel resource set comprises: selecting a random access preamble from a plurality of random access preambles associated with the selected random access channel resource set.

Aspect 5: The method of any of aspects 1 through 4, wherein each random access channel resource set of the plurality of random access channel resource sets is associated with a unique plurality of random access preambles.

Aspect 6: The method of any of aspects 1 through 5, wherein each random access channel resource set of the plurality of random access channel resource sets is associated with a respective random access channel format.

Aspect 7: The method of aspect 6, wherein a first random access occasion comprises two or more portions, each of the two or more portions respectively corresponding to a first random access channel resource set associated with a first random access channel format, a second random access occasion comprises a single portion that corresponds to a second random access channel resource set associated with a second random access channel format different than the first random access channel format, and the first random access occasion and the second random access occasion occupy a same set of time domain resources.

Aspect 8: The method of any of aspects 6 through 7, wherein a first random access channel format is associated with a first quantity of repetitions and a second random access channel format is associated with a second quantity of repetitions that is greater than the first quantity, and one or more first targeted uplink power values of a first range associated with the first random access channel format are greater than one or more second targeted uplink power values of a second range associated with the second random access channel format.

Aspect 9: The method of any of aspects 1 through 8, wherein selecting the random access channel resource set comprises: selecting a random access channel format associated with the selected random access channel resource set, wherein the one or more random access messages are transmitted in accordance with a quantity of repetitions in accordance with the selected random access channel format.

Aspect 10: The method of any of aspects 1 through 9, further comprising: detecting a change in the uplink power value associated with the UE; selecting a second random access channel resource set from the plurality of random access channel resource sets different from the random access channel resource set based at least in part on detecting the change; and transmitting, to the network entity, one or more second random access messages in accordance with one or more second resources of the random access channel resource set based at least in part on selecting the second random access channel resource set.

Aspect 11: The method of any of aspects 1 through 10, further comprising: selecting a second random access channel resource set from the plurality of random access channel resource sets different from the random access channel resource set based at least in part on one or more failures of the one or more random access messages; and transmitting, to the network entity, one or more second random access messages in accordance with one or more second resources of the random access channel resource set based at least in part on selecting the second random access channel resource set.

Aspect 12: The method of any of aspects 1 through 11, further comprising: receiving an indication to use the uplink power value associated with the UE for selecting the random access channel resource set, wherein the selecting is based at least in part on receiving the indication.

Aspect 13: The method of any of aspects 1 through 12, further comprising: receiving one or more reference signals from the network entity; and calculating the uplink power value used based at least in part on an RSRP value measured in accordance with receiving the one or more reference signals.

Aspect 14: A method for wireless communications at a network entity, comprising: configuring a plurality of random access channel resource sets, wherein each random access channel resource set of the plurality of random access channel resource sets is associated with a respective range of targeted uplink power values; outputting, to a UE, a configuration message indicating the plurality of random access channel resource sets based at least in part on configuring the plurality of random access channel resource sets; and obtaining, from the UE, one or more random access messages in accordance with one or more resources of a random access channel resource set in accordance with an uplink power value associated with the UE.

Aspect 15: The method of aspect 14, further comprising: outputting an indication of a mapping between each range of targeted uplink power values and each random access channel resource set, wherein obtaining the one or more random access messages is based at least in part on the indication of the mapping.

Aspect 16: The method of any of aspects 14 through 15, wherein configuring the plurality of random access channel resource sets comprises: allocating a respective quantity of random access occasions to each random access channel resource set of the plurality of random access channel resource sets, wherein the one or more random access messages are obtained in accordance with a random access occasion associated with a random access channel resource set selected by the UE.

Aspect 17: The method of any of aspects 14 through 16, wherein configuring the plurality of random access channel resource sets comprises: allocating a respective plurality of random access preambles to each random access channel resource set of the plurality of random access channel resource sets, wherein the one or more random access messages are obtained in accordance with a preamble associated with a random access channel resource set selected by the UE.

Aspect 18: The method of any of aspects 14 through 17, wherein configuring the plurality of random access channel resource sets comprises: allocating a respective random access channel format to each random access channel resource set of the plurality of random access channel resource sets, wherein the one or more random access messages are obtained in accordance with a random access channel format associated with a random access channel resource set selected by the UE.

Aspect 19: The method of aspect 18, further comprising: allocating a first random access channel format to a first random access channel resource set of the plurality of random access channel resource sets; allocating a second random access channel format different than the first random access channel format to a second random access channel resource set of the plurality of random access channel resource sets; allocating a first random access occasion and a second random access occasion on a same set of time domain resources; and dividing the first random access occasion into two or more portions, each portion respectively corresponding to the first random access channel resource set, wherein the second random access occasion corresponds to the second random access channel resource set.

Aspect 20: The method of any of aspects 18 through 19, wherein a first random access channel format is associated with a first quantity of repetitions and a second random access channel format is associated with a second quantity of repetitions that is greater than the first quantity, and one or more first targeted uplink power values of a first range associated with the first random access channel format are greater than one or more second targeted uplink power values of a second range associated with the second random access channel format.

Aspect 21: The method of any of aspects 14 through 20, further comprising: outputting an indication to use the uplink power value associated with the UE for selection of a random access channel resource set, wherein obtaining the one or more random access messages is based at least in part on outputting the indication.

Aspect 22: The method of any of aspects 14 through 21, further comprising: outputting one or more reference signals to the UE, wherein obtaining the one or more random access messages is based at least in part on outputting the one or more reference signals.

Aspect 23: A UE for wireless communications, comprising one or more memories storing processor-executable code, and one or more processors coupled with the one or more memories and individually or collectively operable to execute the code to cause the UE to perform a method of any of aspects 1 through 13.

Aspect 24: A UE for wireless communications, comprising at least one means for performing a method of any of aspects 1 through 13.

Aspect 25: A non-transitory computer-readable medium storing code for wireless communications, the code comprising instructions executable by one or more processors to perform a method of any of aspects 1 through 13.

Aspect 26: A network entity for wireless communications, comprising one or more memories storing processor-executable code, and one or more processors coupled with the one or more memories and individually or collectively operable to execute the code to cause the network entity to perform a method of any of aspects 14 through 22.

Aspect 27: A network entity for wireless communications, comprising at least one means for performing a method of any of aspects 14 through 22.

Aspect 28: A non-transitory computer-readable medium storing code for wireless communications, the code comprising instructions executable by one or more processors to perform a method of any of aspects 14 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ” As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components. ” The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a configuration message indicating a plurality of random access channel resource sets for the UE, wherein each random access channel resource set of the plurality of random access channel resource sets is associated with a respective range of targeted uplink power values;
select a random access channel resource set from the plurality of random access channel resource sets based at least in part on an uplink power value associated with the UE; and
transmit, to the network entity, one or more random access messages in accordance with one or more resources of the random access channel resource set based at least in part on selecting the random access channel resource set.

2. The UE of claim 1, wherein the one or more processors are individually or collectively further operable to execute the code to cause the UE to:
receive an indication of a mapping between each range of targeted uplink power values and each random access channel resource set, wherein selecting the random access channel resource set is based at least in part on the indication of the mapping.

3. The UE of claim 1, wherein each random access channel resource set of the plurality of random access channel resource sets is associated with a respective quantity of random access occasions.

4. The UE of claim 1, wherein, to select the random access channel resource set, the one or more processors are individually or collectively operable to execute the code to cause the UE to:
select a random access preamble from a plurality of random access preambles associated with the selected random access channel resource set.

5. The UE of claim 1, wherein each random access channel resource set of the plurality of random access channel resource sets is associated with a unique plurality of random access preambles.

6. The UE of claim 1, wherein each random access channel resource set of the plurality of random access channel resource sets is associated with a respective random access channel format.

7. The UE of claim 6, wherein:
a first random access occasion comprises two or more portions, each of the two or more portions respectively corresponding to a first random access channel resource set associated with a first random access channel format;
a second random access occasion comprises a single portion that corresponds to a second random access channel resource set associated with a second random access channel format different than the first random access channel format; and
the first random access occasion and the second random access occasion occupy a same set of time domain resources.

8. The UE of claim 6, wherein:
a first random access channel format is associated with a first quantity of repetitions and a second random access channel format is associated with a second quantity of repetitions that is greater than the first quantity; and
one or more first targeted uplink power values of a first range associated with the first random access channel format are greater than one or more second targeted uplink power values of a second range associated with the second random access channel format.

9. The UE of claim 1, wherein, to select the random access channel resource set, the one or more processors are individually or collectively operable to execute the code to cause the UE to:
select a random access channel format associated with the selected random access channel resource set, wherein the one or more random access messages are transmitted in accordance with a quantity of repetitions in accordance with the selected random access channel format.

10. The UE of claim 1, wherein the one or more processors are individually or collectively further operable to execute the code to cause the UE to:
detect a change in the uplink power value associated with the UE;
select a second random access channel resource set from the plurality of random access channel resource sets different from the random access channel resource set based at least in part on detecting the change; and
transmit, to the network entity, one or more second random access messages in accordance with one or more second resources of the random access channel resource set based at least in part on selecting the second random access channel resource set.

11. The UE of claim 1, wherein the one or more processors are individually or collectively further operable to execute the code to cause the UE to:
select a second random access channel resource set from the plurality of random access channel resource sets different from the random access channel resource set based at least in part on one or more failures of the one or more random access messages; and
transmit, to the network entity, one or more second random access messages in accordance with one or more second resources of the random access channel resource set based at least in part on selecting the second random access channel resource set.

12. The UE of claim 1, wherein the one or more processors are individually or collectively further operable to execute the code to cause the UE to:
receive an indication to use the uplink power value associated with the UE for selecting the random access channel resource set, wherein the selecting is based at least in part on receiving the indication.

13. The UE of claim 1, wherein the one or more processors are individually or collectively further operable to execute the code to cause the UE to:
receive one or more reference signals from the network entity; and
calculate the uplink power value used based at least in part on a reference signal received power (RSRP) value measured in accordance with receiving the one or more reference signals.

14. A network entity, comprising:
one or more memories storing processor-executable code; and
one or more processors coupled with the one or more memories and individually or collectively operable to execute the code to cause the network entity to:
configure a plurality of random access channel resource sets, wherein each random access channel resource set of the plurality of random access channel resource sets is associated with a respective range of targeted uplink power values;
output, to a user equipment (UE), a configuration message indicating the plurality of random access channel resource sets based at least in part on configuring the plurality of random access channel resource sets; and
obtain, from the UE, one or more random access messages in accordance with one or more resources of a random access channel resource set in accordance with an uplink power value associated with the UE.

15. The network entity of claim 14, wherein the one or more processors are individually or collectively further operable to execute the code to cause the network entity to:
output an indication of a mapping between each range of targeted uplink power values and each random access channel resource set, wherein obtaining the one or more random access messages is based at least in part on the indication of the mapping.

16. The network entity of claim 14, wherein, to configure the plurality of random access channel resource sets, the one or more processors are individually or collectively operable to execute the code to cause the network entity to:
allocate a respective quantity of random access occasions to each random access channel resource set of the plurality of random access channel resource sets, wherein the one or more random access messages are obtained in accordance with a random access occasion associated with a random access channel resource set selected by the UE.

17. The network entity of claim 14, wherein, to configure the plurality of random access channel resource sets, the one or more processors are individually or collectively operable to execute the code to cause the network entity to:
allocate a respective plurality of random access preambles to each random access channel resource set of the plurality of random access channel resource sets, wherein the one or more random access messages are obtained in accordance with a preamble associated with a random access channel resource set selected by the UE.

18. The network entity of claim 14, wherein, to configure the plurality of random access channel resource sets, the one or more processors are individually or collectively operable to execute the code to cause the network entity to:
allocate a respective random access channel format to each random access channel resource set of the plurality of random access channel resource sets, wherein the one or more random access messages are obtained in accordance with a random access channel format associated with a random access channel resource set selected by the UE.

19. The network entity of claim 18, wherein the one or more processors are individually or collectively further operable to execute the code to cause the network entity to:
allocate a first random access channel format to a first random access channel resource set of the plurality of random access channel resource sets;
allocate a second random access channel format different than the first random access channel format to a second random access channel resource set of the plurality of random access channel resource sets;
allocate a first random access occasion and a second random access occasion on a same set of time domain resources; and
divide the first random access occasion into two or more portions, each portion respectively corresponding to the first random access channel resource set, wherein the second random access occasion corresponds to the second random access channel resource set.

20. The network entity of claim 18, wherein:
a first random access channel format is associated with a first quantity of repetitions and a second random access channel format is associated with a second quantity of repetitions that is greater than the first quantity; and
one or more first targeted uplink power values of a first range associated with the first random access channel format are greater than one or more second targeted uplink power values of a second range associated with the second random access channel format.

21. The network entity of claim 14, wherein the one or more processors are individually or collectively further operable to execute the code to cause the network entity to:
output an indication to use the uplink power value associated with the UE for selection of a random access channel resource set, wherein obtaining the one or more random access messages is based at least in part on outputting the indication.

22. The network entity of claim 14, wherein the one or more processors are individually or collectively further operable to execute the code to cause the network entity to:
output one or more reference signals to the UE, wherein obtaining the one or more random access messages is based at least in part on outputting the one or more reference signals.

23. A method for wireless communications by a user equipment (UE), comprising:
receiving, from a network entity, a configuration message indicating a plurality of random access channel resource sets for the UE, wherein each random access channel resource set of the plurality of random access channel resource sets is associated with a respective range of targeted uplink power values;
selecting a random access channel resource set from the plurality of random access channel resource sets based at least in part on an uplink power value associated with the UE; and
transmitting, to the network entity, one or more random access messages in accordance with one or more resources of the random access channel resource set based at least in part on selecting the random access channel resource set.

24. The method of claim 23, further comprising:
receiving an indication of a mapping between each range of targeted uplink power values and each random access channel resource set, wherein selecting the random access channel resource set is based at least in part on the indication of the mapping.

25. The method of claim 23, wherein each random access channel resource set of the plurality of random access channel resource sets is associated with a respective quantity of random access occasions.

26. The method of claim 23, wherein selecting the random access channel resource set comprises:
selecting a random access preamble from a plurality of random access preambles associated with the selected random access channel resource set.

27. A method for wireless communications at a network entity, comprising:
configuring a plurality of random access channel resource sets, wherein each random access channel resource set of the plurality of random access channel resource sets is associated with a respective range of targeted uplink power values;
outputting, to a user equipment (UE), a configuration message indicating the plurality of random access channel resource sets based at least in part on configuring the plurality of random access channel resource sets; and
obtaining, from the UE, one or more random access messages in accordance with one or more resources of a random access channel resource set in accordance with an uplink power value associated with the UE.

28. The method of claim 27, further comprising:
outputting an indication of a mapping between each range of targeted uplink power values and each random access channel resource set, wherein obtaining the one or more random access messages is based at least in part on the indication of the mapping.

29. The method of claim 27, wherein configuring the plurality of random access channel resource sets comprises:
allocating a respective quantity of random access occasions to each random access channel resource set of the plurality of random access channel resource sets, wherein the one or more random access messages are obtained in accordance with a random access occasion associated with a random access channel resource set selected by the UE.

30. The method of claim 27, wherein configuring the plurality of random access channel resource sets comprises:
allocating a respective plurality of random access preambles to each random access channel resource set of the plurality of random access channel resource sets, wherein the one or more random access messages are obtained in accordance with a preamble associated with a random access channel resource set selected by the UE.
